(19) United States
(12) Patent Application Publication
(10) Pub. No.: US 2006/0137204 A1
(43) Pub. Date: Jun. 29, 2006

(54) Linear moving capacitive sensor twin column electronic height gauge

(75) Inventor: Zhong Yi Yang, Dong Guan (CN)

Correspondence Address: LAW OFFICE OF BIN LI & ASSOCIATES, Suite 265, 17890 Castleton St., City of Industry, CA, 91748, US

(73) Assignee: International Precision Instrument Corporation, c/o Yanchen Zhang, San Clemente, CA (US)

(21) Appl. No.: 11/303,504

(22) Filed: Dec. 17, 2005

(30) Foreign Application Priority Data
Dec. 27, 2004 (CN) 200420120573.X

(51) Int. Cl. G01B 3/22

(52) U.S. Cl. 33/832

(57) ABSTRACT

The present invention is an electronic height gauge utilizing new technology and includes a first column (Column 1) and a second column (Column 2), a display unit with a cover, a measuring scriber, a fixed capacitance sensor and a linear moving capacitance sensor. The fixed capacitance sensor is located on a flat surface on Column 1, flat surface having a length equivalent to the length of Column 1. The linear moving capacitance sensor is located inside the display unit cover positioned to face the fixed capacitance sensor. The fixed capacitive sensor and linear moving capacitive sensors are facing toward each other only, and do not make direct physical contact with the fixed capacitor sensor when the height gauge is operating in upward and downward movements. The fixed and moving capacitive sensors are instead making only electrical contact with each other when the height gauge is making upward and downward movements. This linear direct data non-contact sensor transfer system results in high accuracy of measurements, which also ensures the repeatability of accurate measurements. Also, since the fixed capacitance sensor and the linear moving capacitance sensor have no physical contact with each other, there is no wear and tear damage on either component part, thereby leading to a longer life of use with stability in accurate measurements and repeatability. Because the measuring system is comparatively simple, and easy to assemble and service and maintain compared to the existing rotary capacitive sensor electronic height gauges that exist on the market, the overall cost of production and maintenance is minimized. On the second column (Column 2), a simple rack and gear system is added. These gears of column 2 are connected to a hand wheel located on the rear of the display unit. The handwheel is used for making upward and downward vertical movements. This rack and gear system of column 2 of the present invention is only used to aid the same in making upward and downward movements, and does not affect the measuring accuracy of the height gauge, as it did in the height gauges that have existed on the market.

PRIORITY DATE OF DEC. 27, 2004

This application is submitted under and claims a priority date of Dec. 27, 2004 to a Chinese Patent Application with associated Patent Number 200420120573.x with filing date of Dec. 27, 2004 and claims priority thereto.

### BACKGROUND OF THE INVENTION

1. Field of the Invention

The present invention relates to the field of gauges and specifically to an electronic twin column height gauge using new technology offering high accuracy of measurements.

2. Brief Description of the Related Art

The measuring technology as applied to electronic twin column height gauges as they currently exist on the market today use a rotary senor system of racks and gears. Racks are usually flat toothed racks (usually located on twin beams) and are geared up with a gear (usually located inside the display unit) thereby creating vertical up and down movements.

The electronic twin column height gauges on the market today utilize a rotary capacitive sensor that is located on the gear that measures the rotations of the gear and transfers the data to a data processor (usually located inside the display unit) which converts the rotary data to linear measurement units and an LCD (liquid crystal display) display will display the readings. The readings are obtained from a rotary moving capacitance system, transforming measurements from a gear and rack.

The flat toothed rack located on these twin beams is matched with a gear located inside the display unit creating vertical up and down movement. The rotary moving capacitive sensor located on the gear provides angle data to a data processor located inside the display unit which converts the rotary angle data to linear measurement units to the LCD display. The structure of the height gauges as they exist on the market today are shown in FIGS. 1, 2, 3 & 4. In FIG. 1, (5) column 1 and (8) Column 2 are assembled on (1) Base. On the inward side of (5) Column 1 and (8) Column 2 are two rows of (7) machined toothed racks. Those (7) racks are working with the (15) gear system in FIG. 2 creating a rack and gear measuring system. When the (14) handwheel is in use, the (15) gear system and the (5) Column 1 and (8) Column 2 complement each other and create a linear up and down movement. In FIGS. 3 & 4, a (16) Rotary moving capacitive sensor is fixed on the gear. As the gear moves on the rack it provides the rotary moving capacitive sensor with transfer information in the form of “Angle rotary moving data” to a (17) fixed capacitive sensor located inside the (4) display unit cover. After the (17) fixed capacitive sensor processes the angle rotary movement data to linear movement data, it then transfers to measurement units displaying the readings on the (3) LCD display. The (2) buttons are used for setting zero and making unit changes between metric units and inch measurement units. The measuring principle of the existing height gauges only calculates the linear measurements using a gear and rack. For height gauges as they exist on the market, it is very important to understand that only the rack and gear affect the accuracy of the measurements. In the situations when dirt and debris accumulate on the surface of the rack or the gear, or after periods of long term wear, the accuracy of the readings will be affected. The traditional rack and gear systems working with a complicated data transferring system also may create improper readings and errors. In summary the traditional electronic twin column height gauges have problems including that of a complicated structure, complicated assembly, high maintenance, high costs, and lower measurement accuracy.

In summary, the setbacks of the existing electronic twin column height gauges have resulted in higher costs, and lower measurement accuracy.

The Electronic Twin Column Height Gauge of the present invention solves the problems of the height gauges as they exist on the market today and offers advantages over its predecessor by having a less complicated construction compared to the existing twin column electronic height gauges. It offers high accuracy of readings with good repeatability, longer life, simpler assembly and maintenance, thereby leading to overall lower costs.

The present invention utilizes a newly invented electronic twin column height gauge with the following principle parts comprising two single columns (Column 1) and (Column 2), display units with cover and measuring scriber, a fixed capacitance sensor, and a linear moving capacitance sensor. An additional technical improvement for this new electronic height gauge is that the fixed capacitance sensor is placed in a shallow groove on the flat side of Column 1. The linear moving capacitance sensor is installed inside the display unit cover and facing the fixed capacitance sensor in Column 1. The moving capacitance sensor will transfer data to an electronic processor located in the display unit cover with an increased speed and display the reading from the LCD display.

For this new invention, there is a flat surface on Column 1, and a fixed capacitance sensor is installed on this flat surface with the same length of Column 1. On the flat surface of Column 1, a shallow groove is required for the assembling of the fixed capacitance sensor. A toothed rack is applied on the surface of Column 2. A hand wheel is assembled in the back of the display unit connected to a gear inside the display unit. The hand wheel, gear, and toothed rack on Column 2 work in conjunction thereby creating up and downward movements for the display unit.

The principle parts for this new electronic twin column height gauge as shown in FIG. 5 and FIG. 6 includes a first column (5) (Column 1) and a second column (8) (Column 2), a display unit with a cover and a measuring scriber, a fixed capacitance sensor and a linear moving capacitance sensor. The fixed capacitance sensor is located on a flat surface on Column 1 with the length equivalent to the length of Column 1. The linear moving capacitance sensor is located inside the display unit cover with its position facing the fixed capacitance sensor. Because the fixed and moving capacitance sensors are facing toward each other, the moving capacitance sensor is making direct electrical contact (but not direct physical contact) with the fixed capacitance sensor when the height gauge is making upward and downward movements. This direct electrical contact sensor system results in high accuracy of measurements, which also ensures the repeatability of accurate measurements. Also, since the fixed capacitance sensor and the moving capacitance sensor receive no physical contact with each other, there is no wear and tear on either part, thereby leading to a longer life of use. Because the measuring system is very simple, and easy to assemble and service unlike the old fashioned height gauges, it will help to lower the overall cost.

On Column 2, of the new invention a simple rack and gear system is added. The gear is connected to a hand wheel on the back of the display unit, and making up and downward movements. This rack and gear system is only created to aid display unit to make upward and downward movements, and does not affect the accuracy of the height gauge as it does in the height gauges that exist on the market today.

### SUMMARY OF THE INVENTION

The new electronic twin column height gauge of the present invention has a simpler structure compared to the existing electronic twin column height gauges as they exist on the market. The present invention gives high accuracy of readings and accurate repeatability, a longer lifetime, and easy installation and servicing, all leading to an overall lower cost.

The principal parts for this new height gauge includes a first column “Column 1”, and a second column “Column 2”, a display unit with a cover and measuring scriber, a fixed capacitance sensor and a linear moving capacitance (capacitive) sensor. The fixed capacitance sensor is located on a flat surface of Column 1 with the length equivalent to the length of Column 1. The linear moving capacitance sensor is located inside the display unit cover with its position facing the fixed sensor. The linear moving capacitance sensor and the fixed capacitance sensors face toward each other without any direct physical contact. However, the linear moving capacitance sensor is making direct electrical contact with the fixed capacitance sensor when the height gauge is making upward and downward movements.

Because of the movement between the fixed capacitive sensors and the linear moving capacitance sensors which are facing each other without physical contact, the linear moving capacitive sensor is electronically transferring the measurement as it travels along the fixed capacitive sensor when the height gauge is operating in an upward and downward vertical position. This linear direct data transfer sensor system results in high accuracy of measurements, which also ensures accurate measurement repeatability. Also, since the moving and fixed capacitance sensors are not in physical contact with each other, there is no damage from wear for either part, which will lead to a longer life span.

Because the measuring system is very simple and easy to assemble and service unlike the old fashioned height gauges as they exist on the market today, the new invention offers advantages including higher accuracy, higher reliability and a reduced overall cost.

To reiterate, the fixed capacitance sensor of the present invention is placed in a shallow groove on the flat side of Column 1. The moving capacitance sensor is placed inside the display unit cover and facing the fixed capacitance sensor on Column 1. On Column 2, a simple rack and gear system is added. The gear is connected to a hand wheel on the back of the display unit, and making upward and downward movements.

FIGS. 5; 6; 7; 8; and 9 show the structure of the new electronic twin column height gauge of the present invention. It includes (5) Column 1, (8) Column 2, (9) measuring scriber, (6) fixed capacitance sensor and (13) linear moving capacitance sensor. (5) Column 1 and (8) Column 2 are assembled on (1) Base. The (6) fixed capacitance sensor is placed in a shallow groove on a flat surface on (5) Column 1. The (13) linear moving capacitance sensor is placed inside the (4) display unit cover and facing the (6) fixed capacitance sensor. (5) Column 1 and (8) Column 2 are installed on (1) base. There is a flat surface on (5) Column 1 which is required for the installation of (6) fixed capacitance sensor. On (8) Column 2, a simple (7) rack and (10) gear system is added. The (10) gear is connected to a (14) hand wheel on the back of the (4) display unit. Inside (4) display unit cover, it also includes (12) the main electronic processor, (3) LCD display, and (11) cable. When there is rotary movement on the (14) hand wheel thereby causing (4) display unit in making upward and downward movements, (13) linear moving capacitance sensor can quickly receive and read the data from the movement of (4) display unit and display on (3) LCD display. (2) Buttons can set the unit to zero and convert units between inches (in) and millimeters (mm). The (7) toothed rack on (8) Column 2 and (10) gear are only created to help (4) display unit to make upward and downward movements, and does not affect the accuracy of the height gauge. Also, the (13) linear moving capacitance sensor and (6) fixed capacitance sensor do not physically touch each other, and there is no wear or tear damage for either part which will lead to a longer lifecycle.

The present invention has the advantages over the prior art as described above by offering in a newly invented twin column electronic height gauge as described herein. In accordance with a preferred embodiment of the invention, there is disclosed a twin column electronic height gauge with the following principle components and comprising two single columns (Column 1) and (Column 2), display units with cover and measuring scriber, a fixed capacitance sensor, and a linear moving capacitance sensor.

To reiterate, the fixed capacitance sensor is placed in a shallow groove on the flat side of Column 1. The linear moving capacitance sensor is installed inside the display unit cover and facing the fixed capacitance sensor in Column 1. The linear moving capacitance sensor will transfer data to an electronic processor located in the display unit cover and display the reading from the LCD display. For this new invention, there is a flat surface on Column 1, and a fixed capacitance sensor is installed on this flat surface with the same length of Column 1. On the flat surface of Column 1, a shallow groove is required for the assembling of the fixed capacitance sensor. A toothed rack is applied on the surface of Column 2. A hand wheel is assembled in the back of the display unit connected to a gear inside the display unit. The hand wheel, gear, and toothed rack on Column 2 work in conjunction thereby creating up and downward movements for the display unit.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

FIG. 1 shows an electronic twin column height gauge as they exist on the market today.

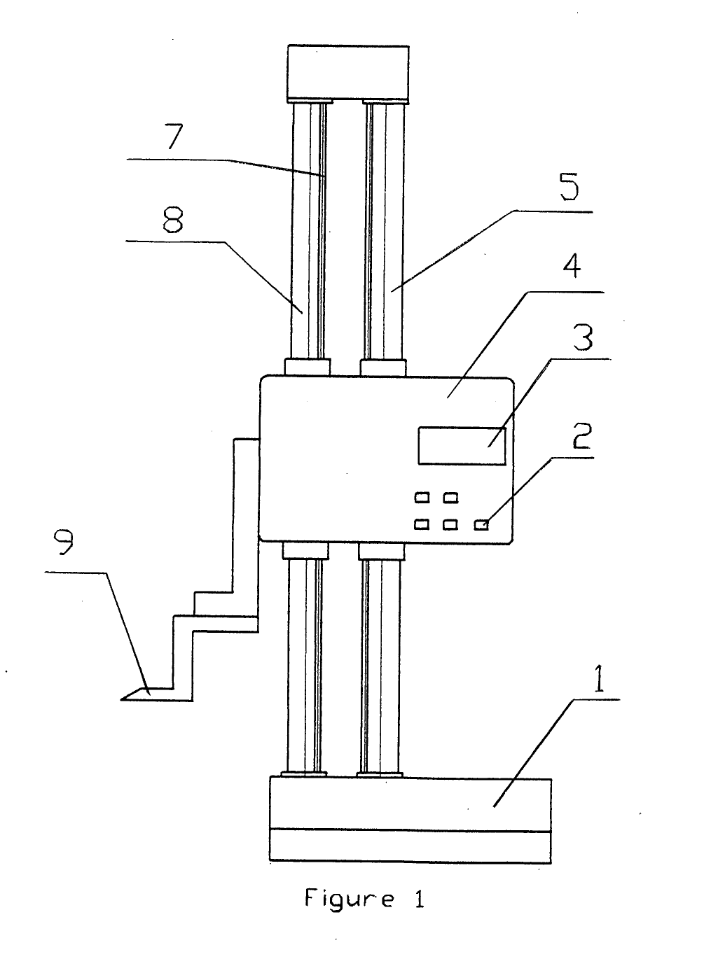

FIG. 2 shows a cross-section view from the top of a twin column height gauge as they exist on the market.

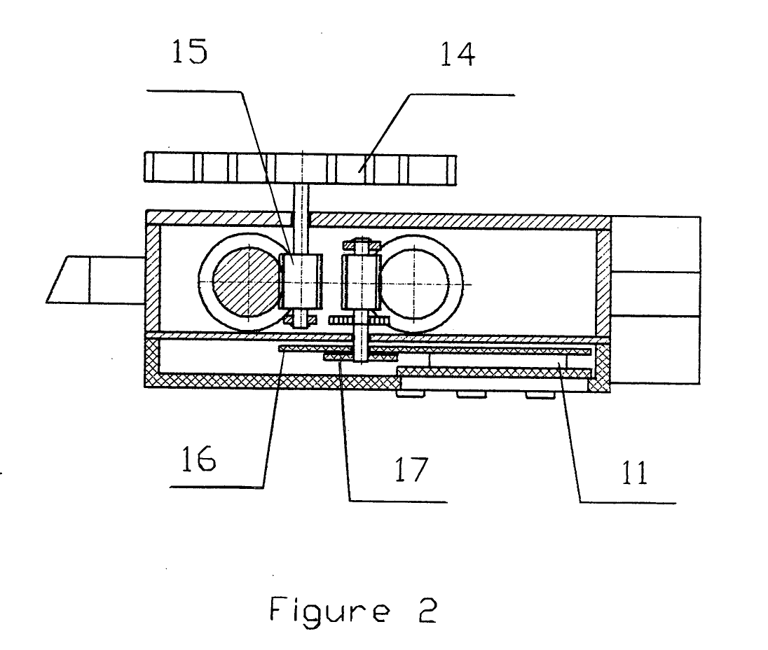

FIG. 3 shows a (16) rotary moving capacitance sensor and (17) fixed capacitance sensor (as they exist on market).

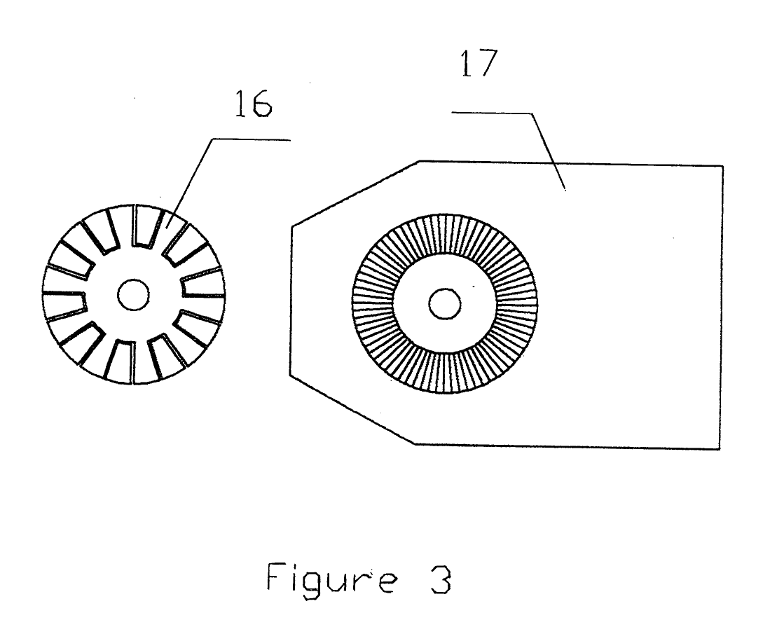

FIG. 4 shows the movement of an existing sensor system created by a gear system as they exist on the market.

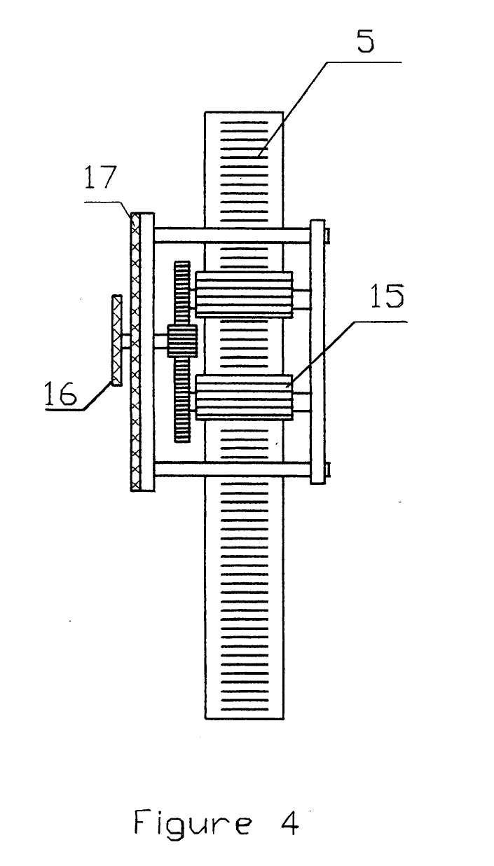

FIG. 5 shows the new linear moving capacitive sensor electronic twin column height gage of the present invention.

FIG. 6 shows a cross section view from the top of the new linear moving capacitive sensor electronic twin column height gage of the present invention.

FIG. 7 shows the new linear moving and fixed capacitive sensor system of the present invention.

FIG. 8 shows the new linear moving and fixed capacitive sensor of the present invention facing each other without any physical contact.

FIG. 9 shows the simple rack and gear system of the new linear moving capacitive sensor electronic twin column height gage creating upward and downward vertical movement.

### DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring to the drawing figures, like reference numerals designate identical or corresponding elements throughout the several figures, there is disclosed: (1) Base; (2) Buttons; (3) LCD Display; (4) display unit with cover; (5) Column 1; (6) fixed capacitance sensor; (7) toothed rack; (8) Column 2; (9) measuring scriber; (10) gear; (11) cable; (12) main electronic processor; (13) linear moving capacitance sensor; (14) handwheel.

The above features differ from those that exist on the market today: (15) gear system (existing on market); (16) rotary moving capacitance sensor (existing on market); (17) fixed capacitance sensor (existing on market).

In accordance with a preferred embodiment of the invention, there is disclosed a new electronic twin column height gauge having a simpler structure compared to the existing twin column height gauges as they exist on the market. The present invention enables high accuracy of readings, good repeatability, longer lifetime, and easy installation and servicing, which will lead to an overall lower cost. In comparison to the existing technologies, the uniqueness of this invention is set forth as the following:

The principal parts for this new electronic twin column height gauge includes: Column 1, Column 2, display unit with cover and measuring scriber, a fixed capacitance sensor and a linear moving capacitance sensor. The fixed capacitance sensor is located on a flat surface of the Column 1 with the length equivalent to the length of Column 1. The linear moving capacitance sensor is located inside the display unit cover with its position facing the fixed sensor. The moving and the fixed capacitance sensors do not make direct physical contact however are making a direct electrical contact with the fixed capacitance sensor when the height gauge is making upward and downward movements. This direct electrical contact sensor system results in high accuracy of measurements, which also ensures high measuring repeatability and accuracy. Also, since the moving and fixed capacitance sensor are not in physical contacts with each other, there is no wear damage for either part, which will lead to a longer lifecycle. Because the measuring system is very simple and easy to assemble and service unlike the old fashioned height gauges, it will help to reduce the overall cost.

The fixed capacitance sensor is placed in a shallow groove on the flat side of Column 1. The moving capacitance sensor is placed inside the display unit cover and facing the fixed capacitance sensor on Column 1. On Column 2, a simple rack and gear system is added. The gear is connected to a hand wheel on the back of the display unit, and making upward and downward movements.

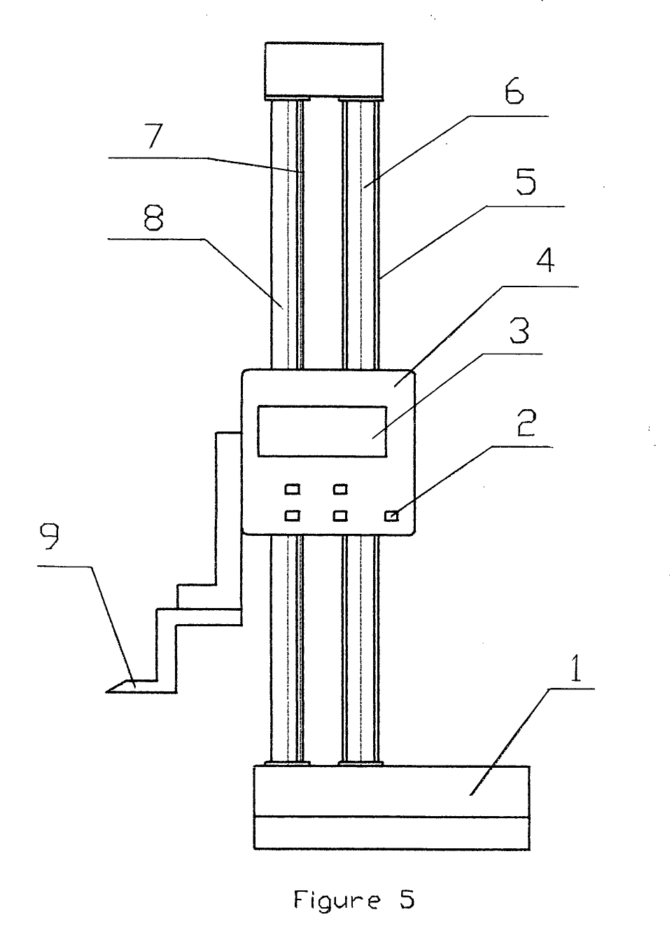

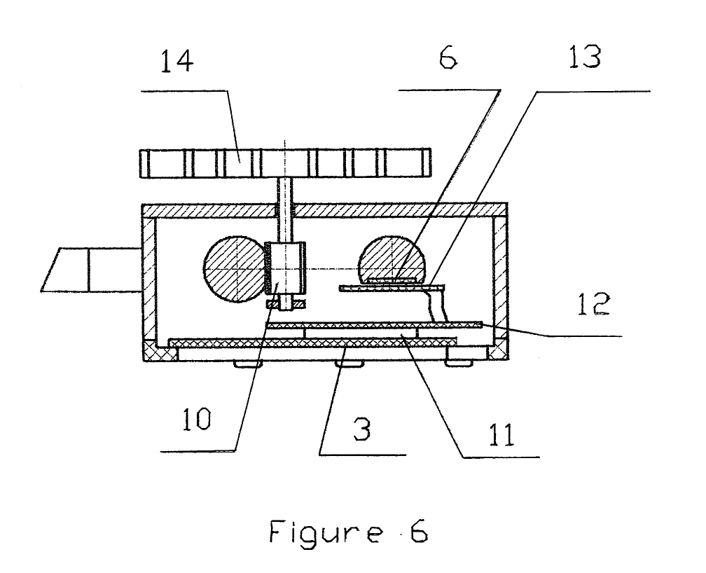

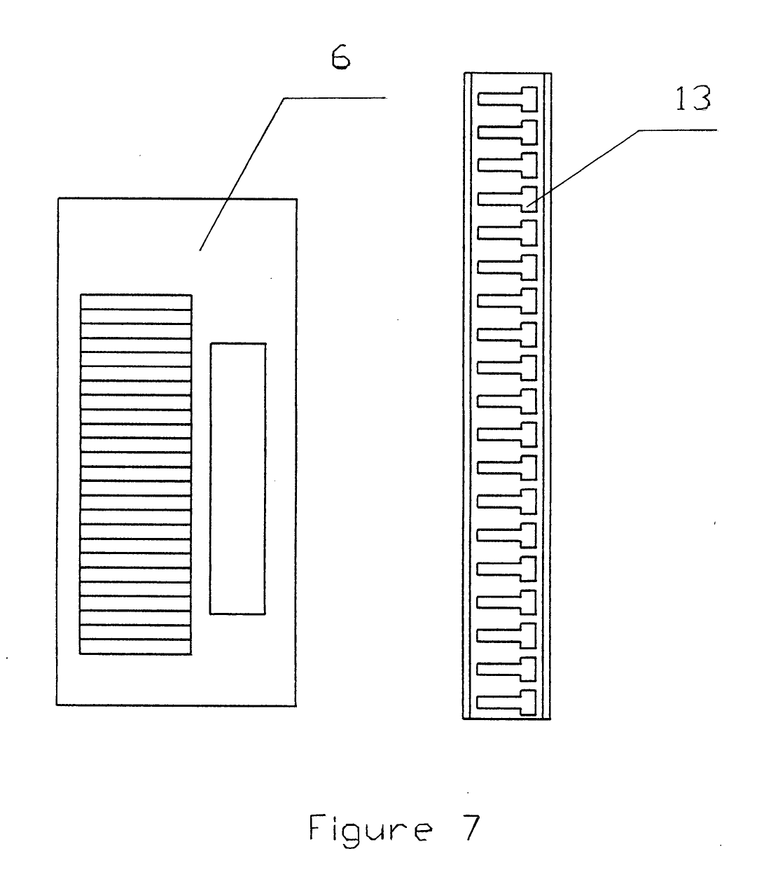

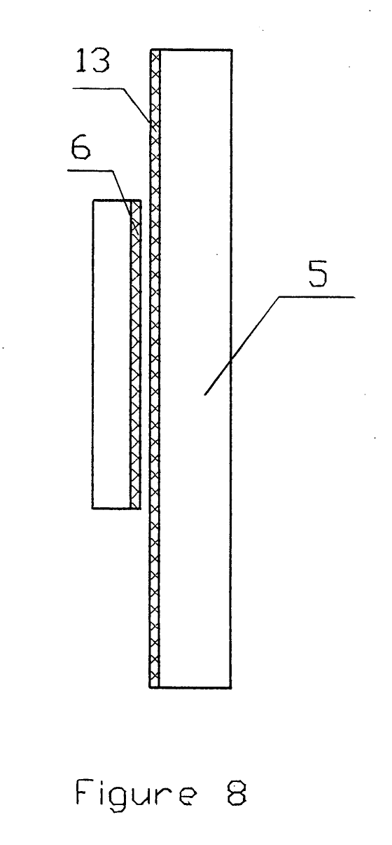

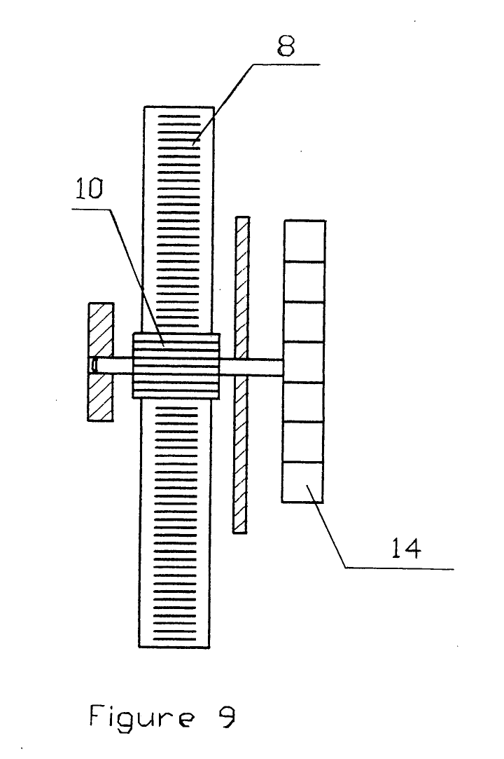

FIGS. 5, 6, 7, 8 & 9 show the structure of the new linear moving capacitive sensor electronic twin column height gage. It includes (5), Column 1, (8) Column 2, (9) Measuring Scriber, (6) Fixed Capacitive Sensor and (13) Linear Moving Capacitive Sensor, (5) Column 1 and (8) Column 2 are assembled on (1) Base. The (6) fixed capacitive sensor is placed in a shallow groove on a flat surface of (5) Column 1. The (13) Linear moving Capacitive Sensor is placed inside the (4) display unit cover and faces the (6) fixed capacitive sensor as shown in FIG. 8. There is a flat surface on (5) Column 1 which is required for the installation of (6) fixed capacitive sensor. On (8) Column 2 a simple (7) rack and (10) gear system is added. The (10) gear is connected to a (14) handwheel on the back of the (4) display unit. Inside the (4) display unit cover, includes (12) the main electronic processor, (3) LCD display and (11) cable. The rotation of the handwheel (14) controls upward and downward vertical movements. The (13) linear moving capacitive sensor receives linear data from the vertical movement and transfers the data to the (3) LCD display. The (2) buttons can set the unit to zero and convert measuring units to either inch units or metric units. The (7) tooth rack on (8) Column 2 and (10) gear as shown in FIG. 9, provide the display unit with upward and downward vertical movement, and does not affect the accuracy of the height gage. The (13) linear moving capacitive sensor facing the (6) fixed capacitive sensor do not contact each other, as shown in FIGS. 7 & 8, eliminating wear damage, which will lead to high accuracy of readings, good repeatability and longer life cycles.

Still other objects, features, and attendant advantages of the present invention will become apparent to those skilled in the art from a reading of the above detailed description of embodiments constructed in accordance therewith, taken in conjunction with the accompanying drawings.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention described by the foregoing includes all changes that come within the meaning, range and equivalence thereof and is intended to be embraced therein.

What is claimed is:

1. A twin column electronic height gauge comprising:
a first column and a second column;
a display unit with cover and measuring scriber;
a fixed capacitive sensor;
a linear moving capacitive sensor;
whereby an apparatus providing accurate and precise measurements will be provided.

2. The fixed capacitive sensor of claim 1, wherein said fixed capacitive sensor is placed in a shallow groove on a flat side of said first column;

3. The first column of claim 1 further comprising a flat surface on said first column; said fixed capacitive sensor is installed on said flat surface, said flat surface having a length equal to that of entire said first column.

4. The flat surface of the first column as in claim 3, wherein a shallow groove is incorporated for the assemblage of said fixed capacitive sensor.

5. The second column as in claim 1, wherein a toothed rack is applied on the surface of said second column whereby a hand wheel is assembled to a rear portion of said display unit coupled to a gear inside said display unit.

6. The hand wheel according to claim 5, wherein said gear, and said toothed rack on said second column work in conjunction thereby creating controlled upward and downward movements, thereby causing images to be sent to said display unit.

7. The linear moving capacitive sensor of claim 1, wherein said linear moving capacitive sensor is installed inside said display unit cover and facing said fixed capacitive sensor attached to said first column;

8. The linear moving capacitive sensor of claim 7 having no direct physical contact with said fixed capacitive sensor; said linear moving capacitive sensor having electrical contact with said fixed capacitive sensor thereby causing a transfer of data to an electronic processor located in said display unit cover and thereby causes a display of figures to be viewed on an LCD display.
